(19) United States
(12) Patent Application Publication
(10) Pub. No.: US 2015/0371318 A1
(43) Pub. Date: Dec. 24, 2015

(54) SYSTEM FOR COMBINED ORDERS DURING BATCH PRINTING

(71) Applicants: Ronen Hen, Skokie, IL (US); Refael Yitzhaki, Des Plaines, IL (US)

(72) Inventors: Ronen Hen, Skokie, IL (US); Refael Yitzhaki, Des Plaines, IL (US)

(21) Appl. No.: 14/731,139

(22) Filed: Jun. 4, 2015

Related U.S. Application Data
(60) Provisional application No. 62/014,056, filed on Jun. 18, 2014.

(51) Int. Cl. G06Q 30/06

(52) U.S. Cl. CPC G06Q 30/0635

(57) ABSTRACT

An order fulfillment management system including: a controller; a network interface; and a memory, wherein the controller is configured to: receive one or more data streams of orders from the network interface, each order including a plurality of fields, wherein each field is identified by a corresponding field identifier, wherein the plurality of fields include a field identified by a corresponding field identifier as a product field and fields identified by corresponding field identifiers as portions of an address; assign a unique identifier to two or more orders of the one or more data streams of orders having matching fields specified by a match pattern to form a match, wherein the match pattern specifies a plurality of field identifiers; and generate a packing list for the match including the unique identifier and a product field for the two or more orders of the match.

### CROSS-REFERENCE TO RELATED APPLICATIONS

This application incorporates by reference and claims the benefit of priority to U.S. Provisional Patent Application No. 62/014,056 filed Jun. 18, 2014.

### BACKGROUND OF THE INVENTION

The present subject matter relates generally to an order fulfillment management system that combines orders during batch printing of packing lists. More specifically, the present invention relates to a system for combining orders across separately received data streams of orders, such as data streams from multiple suppliers, data streams received at different times, and data streams of differing formats such that the combined orders can be shipped more efficiently.

Suppliers such as manufacturers, wholesalers, retailers, and individuals typically maintain a physical or virtual inventory (off site in the case of a drop-shipping service) of products for sale to consumers. Suppliers increasingly sell through multiple channels, such as web storefronts and or third party platforms, and may continuously receive orders for shipment or fulfillment from one or more retailers.

Generally, suppliers may pull or receive their own orders (as a downloadable file or direct data stream) from any of the channels or platforms where their products are offered and ordered have been created or submitted for said products. In the case of a drop-shipping service (also known as third-party fulfillment), periodic data streams or batches will be received via FTP, email, or any other electronic transmission from retailers. A data stream will include one or more data lines wherein each line includes information about the order such as the name, address and product to ship identified by any form of reference in the data line to an inventory system or an order management system. The supplier will additionally choose a carrier to deliver products from the supplier's storage facility to the consumer. The supplier will then “print” the order by printing a packing list and a shipping label. The shipping label may be generated by using carrier-supplied software to communicate the order information to the carrier and generating a shipping label using the shipping information received in response.

Increasingly, the nature of Internet shopping is reducing consumer use of multi-product orders while proliferating the number of items sold and shipped to a single customer. For example, consumers of daily deals, or similar limited time offers, often purchase a deal and then share the deal with friends and family. The consumer may then be asked by friends and family to purchase the product on their behalf and this may result in a plurality of separate orders made at different times to be delivered to the same address. Alternatively, when a daily deal has a limit, some consumers may utilize multiple accounts to bypass the limit and complete several purchases which may additionally result in a plurality of separate orders made at different times to be delivered to the same address. Because shipping costs may be significant relative to the costs of the goods being shipped, there is a need for systems and methods that reduce shipping costs.

Accordingly, there is a need for an order fulfillment management system that aggregates products across orders into a single delivery package.

### BRIEF SUMMARY OF THE INVENTION

To meet the needs described above and others, the present disclosure provides an order fulfillment management system that aggregates products across multiple orders into a single delivery package.

In one embodiment, the fulfillment process begins with the receiving of a data stream of orders by the order fulfillment management system. Orders may be received as a file transferred by file transfer protocol (FTP), via an application programming interface (API), etc. The data stream may be a comma-separated values text file, a text file of any other delimiter-separated values, etc. The data stream may include a plurality of data lines. Each data line may include information regarding an order, such as the product ordered (such as may be represented by a SKU number), the address where the product is to be shipped, and other information regarding the shipment separated into various information columns.

In the next step, one or more match patterns are run on the data stream to match orders. A match pattern is a choice of two or more columns of an order. In one example, a match pattern includes a street address column, a city column, a country column, and a postal code column. In some embodiments, the match pattern may include a consumer's name column. Similarly, in some embodiments, the match pattern may include a telephone number column.

As indicated by the match pattern, two or more fields (such as: name, address etc.) from each data line in the data stream will be combined to form at least one unique string that may act as a data line identifier. For a line in the data stream, the data line identifier is compared to all other data line identifiers from the data stream using the match pattern. In some embodiments, the data line identifiers for two data lines must match identically in order to find a match. In other embodiments, a match may be found where the patterns include unimportant differences. For example, a match may be found where one line includes “233 S. Wacker Dr.” and the other line includes “233 South Wacker Drive”.

Additionally, in some embodiments, the match pattern may be run across multiple data streams. For example, when a data stream is received, there may exist previously received data streams that remain unprinted. The match pattern may then be run between the data stream and the previously received data streams. Likewise, after a data stream is received, it may be held unprinted until the passage of a period of time or until a number of other data streams have been received. The match pattern may then be run against the data stream and the later-arriving data streams.

For each collection of matched lines, the matched lines are removed from the data stream, formed into a combined order, and assigned a unique identifier, such as a barcode or any combination of charters and or alphanumeric value. The uncombined lines are then printed as normal, producing a packing list and/or shipping label for each line. The combined orders are then printed on a packing list or any manifest document for product picking from the warehouse or storage facility, and for each order the packing list includes each of the products of the combined order along with the unique identifier. A shipping label is also printed for each combined order by communicating the combined order, including the total value and weight of the combined products, to the carrier, and receiving back a shipping label including a tracking number. Based on the saved matching pattern for all combined orders, tracking numbers will be provided and multiplied whenever orders were combined. Thus, if three orders were combined, the same tracking number will be provided for all three orders. The tracking number may then be communicated back to the customer, for example, by an email notification that the order has shipped.

In an embodiment, an order fulfillment management system includes a controller; a network interface coupled to the controller; and a memory coupled to the controller, wherein the memory is configured to store program instructions executable by the controller, wherein in response to executing the program instructions, the controller is configured to: receive one or more data streams of orders from the network interface, each order including a plurality of fields, wherein each field is identified by a corresponding field identifier, wherein the plurality of fields include a field identified by a corresponding field identifier as a product field, wherein the plurality of fields include fields identified by corresponding field identifiers as portions of an address; assign a unique identifier to two or more orders of the one or more data streams of orders having matching fields for each of one or more fields specified by a match pattern to form a match, wherein the match pattern specifies a plurality of field identifiers; and generate a packing list for the match including the unique identifier and a product field for the two or more orders of the match.

In some embodiments, the two or more orders include a first order and a second order, wherein the first order is received in a first data stream of orders, wherein the second order is received in a second data stream of orders, wherein the first data stream of orders is distinct from the second data stream of orders, wherein the second data stream of orders is received a period of time after the first data stream of orders is received. For example, in some embodiments, the period of time is one day or greater. As another example, in some embodiments, the period of time is two days or greater. In further examples, the period of time is three days or greater.

In some embodiments, the one or more field identifiers specified by the match pattern includes a street address field, a city field, a state field, a country field, and a postal code field. And, in some embodiments, wherein the one or more field identifiers specified by the match pattern further includes a consumer's name field. Moreover, in some embodiments, the one or more field identifiers specified by the match pattern further includes a telephone number field. Further, in some embodiments, the one or more field identifiers specified by the match pattern includes a consumer's name field, a street address field, a city field, a state field, a country field, a postal code field, and a telephone number field.

In some embodiments, the controller is further configured to, before the step of assigning a unique identifier, correct errors in the one or more fields specified by the match pattern for each order of the one or more data streams of orders, wherein errors include misspellings, incorrectly joined elements, improperly ordered elements, and missing elements. In further embodiments, errors further include incorrect letter case. In even further embodiments, errors further include nonstandard abbreviations.

In some embodiments, the system includes a printer coupled to the controller, wherein the controller is further configured to: communicate the match to a carrier system, including a total value and a weight of two or more combined products; receive an electronic file including an electronic representation of a shipping label including a tracking number from the carrier system; and print the shipping label based on the electronic representation of the shipping label via the printer. Similarly, in some embodiments, the system includes a printer coupled to the controller, wherein the controller is further configured to: print the packing list via the printer.

In some embodiments, to assign the unique identifier, the controller is further configured to: concatenate two or more fields of each order of the one or more data streams of orders according to the match pattern to form a data line identifier; and assign the unique identifier to the two or more orders of the one or more data streams of orders having matching data line identifiers to form the match.

In an embodiment, an order fulfillment management system includes: a controller; a network interface coupled to the controller; one or more printers in communication with the controller; and a memory coupled to the controller, wherein the memory is configured to store program instructions executable by the controller, wherein in response to executing the program instructions, the controller is configured to: receive one or more data streams of orders from the network interface, each order including a plurality of fields, wherein each field is identified by a corresponding field identifier, wherein the plurality of fields include a field identified by the corresponding field identifier as a product field, wherein the plurality of fields include fields identified by the corresponding field identifiers as portions of an address; assign a unique identifier to two or more orders of the one or more data streams of orders having matching fields for each of one or more fields specified by a match pattern to form a match, wherein the match pattern specifies a plurality of field identifiers; generate a packing list for the match including the unique identifier and the product fields for the two ore more orders of the match; communicate the packing list to one of the printers; communicate the match to a carrier system, including a total value and a weight of two or more combined products; receive an electronic file including an electronic representation of a shipping label including a tracking number from the carrier system; and communicate the electronic representation of the shipping label to one of the printers.

In some embodiments, the two or more orders include a first order and a second order, wherein the first order is received in a first data stream of orders, wherein the second order is received in a second data stream of orders, wherein the first data stream of orders is distinct from the second data stream of orders, wherein the second data stream of orders is received a period of time after the first data stream of orders is received. Additionally, in some embodiments, the one or more field identifiers specified by the match pattern includes a street address field, a city field, a state field, a country field, and a postal code field.

In some embodiments, the controller is further configured to: for each order of the one or more data streams of orders, before the step of assigning a unique identifier, correct errors in the each field specified by the match pattern, wherein the errors include misspellings, incorrectly joined elements, improperly ordered elements, incorrect letter case, nonstandard abbreviations, and missing elements.

In an embodiment, an order fulfillment management system includes: a controller; a network interface coupled to the controller; one or more printers; and a memory coupled to the controller, wherein the memory is configured to store program instructions executable by the controller, wherein in response to executing the program instructions, the controller is configured to: receive one or more data streams of orders, each order including a plurality of fields, wherein each field is identified by a corresponding field identifier, wherein the plurality of fields include a field identified by the corresponding field identifier as a product field, wherein the plurality of fields include fields identified by the corresponding field identifiers as portions of an address; after a predetermined period of time elapses after receipt of at least one of the one or more data streams of orders, form a match by assigning a unique identifier to two or more orders of the one or more data streams of orders having matching fields for each of one or more fields specified by a match pattern, wherein the match pattern includes a plurality of field identifiers; generate a packing list for the match including the unique identifier and the product field data for each order in the match; communicate the packing list to one of the printers; communicate the match to a carrier system, including a total value and a weight of two or more combined products; receive an electronic file including an electronic representation of a shipping label including a tracking number from the carrier system; and communicate the electronic representation of the shipping label to one of the printers.

In an embodiment, an order fulfillment management system including: a controller; a network interface coupled to the controller; and a memory coupled to the controller, wherein the memory is configured to store program instructions executable by the controller, wherein in response to executing the program instructions, the controller is configured to: receive a first order from the network interface, the first order associated with a user-specified period of time; during the specified period of time, receive one or more data streams of orders from the network interface, wherein each order of the first order and the data streams of orders include a plurality of fields, wherein each field is identified by a corresponding field identifier, wherein the plurality of fields include a field identified by a corresponding field identifier as a product field, wherein the plurality of fields include fields identified by corresponding field identifiers as portions of an address; assign a unique identifier to the first order and a second order of the one or more data streams of orders to form a match, wherein the fields of the first order and the second order specified by a match pattern match identically; and generate a packing list for the match including the unique identifier and a product field for the two or more orders of the match.

An advantage of the invention is that it provides a system for suppliers to combine multiple orders intended for the same customer made at different times.

Another advantage of the invention is that it provides a system to combine multiple orders intended for the same customer made with different retailers.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a diagram illustrating the ecosystem of an example of the order fulfillment management system.

FIG. 2 is a flowchart illustrating an example of an order fulfillment management method executed by the order fulfillment management system.

FIG. 3A is a table view illustrating an example of a data stream received by the order fulfillment management system.

FIG. 3B is a table view illustrating various examples of match patterns that may be utilized by the order fulfillment management system.

FIG. 3C is a table view illustrating various examples of data line identifiers generated by the order fulfillment management system using a match pattern.

FIG. 3D is an example of selected rows of a data stream identified by the order fulfillment management as having identical data line identifiers.

FIG. 4 is a table illustrating various example errors in an example order and their corrected form as may be determined by the order fulfillment management system.

FIG. 5A is an example of a packing list generated by the order fulfillment management system.

FIG. 5B is an example of a shipping label generated by the order fulfillment management system via communication with a carrier system.

### DETAILED DESCRIPTION OF THE INVENTION

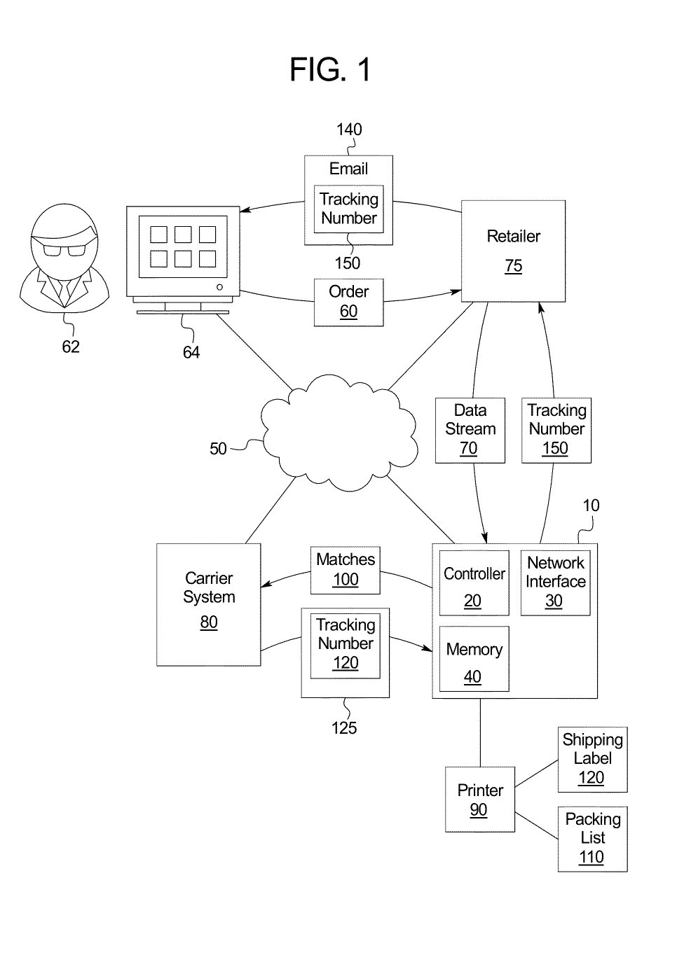

FIG. 1 illustrates the ecosystem of an example of an order fulfillment management system 10. A customer 62 may browse an online store of the retailer 15 using a customer machine 64, and upon finding a desired item, may generate an order 60 that is communicated to the retailer 15 over a network 50. Occasionally, after making an order 60, a customer 62 may return to the online store of the retailer 15 and make an additional order 60. The orders 60 may be included in one or more data streams 70 that are transmitted to the order fulfillment management system 10 for fulfillment. The order fulfillment management system 10 may then generate matches 100 of orders 60 that may be combined to generate packing lists 110 and shipping labels 120 to permit the supplier to ship the orders 60 as a combined order 60.

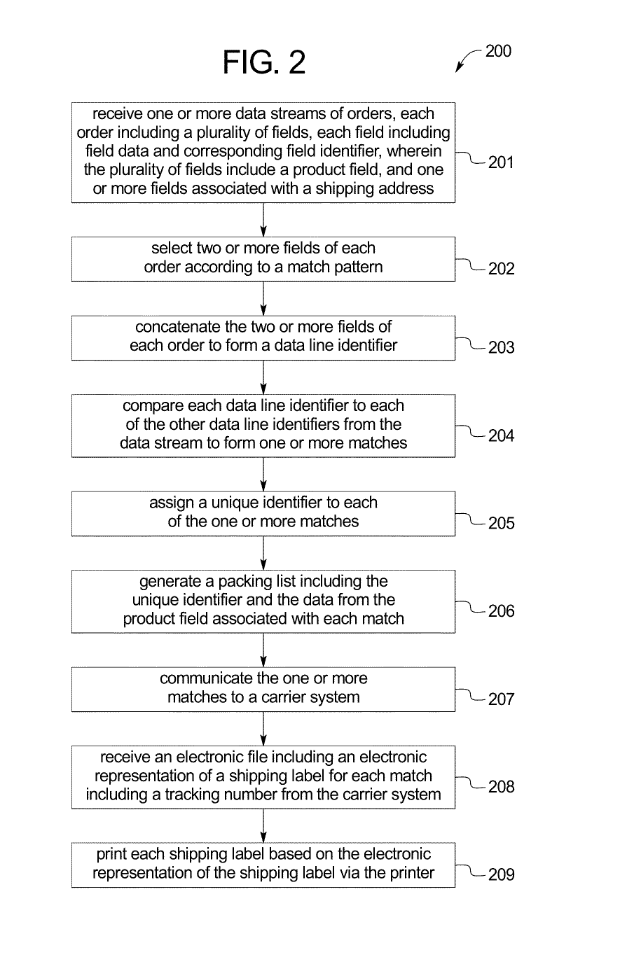

As shown in FIG. 1, the shipping management system 10 includes a controller 20; a network interface 30 coupled to the controller; and a memory 40 coupled to the controller 20. The memory 40 may store program instructions executable by the controller 20 to carry out the order fulfillment management method 200 of FIG. 2.

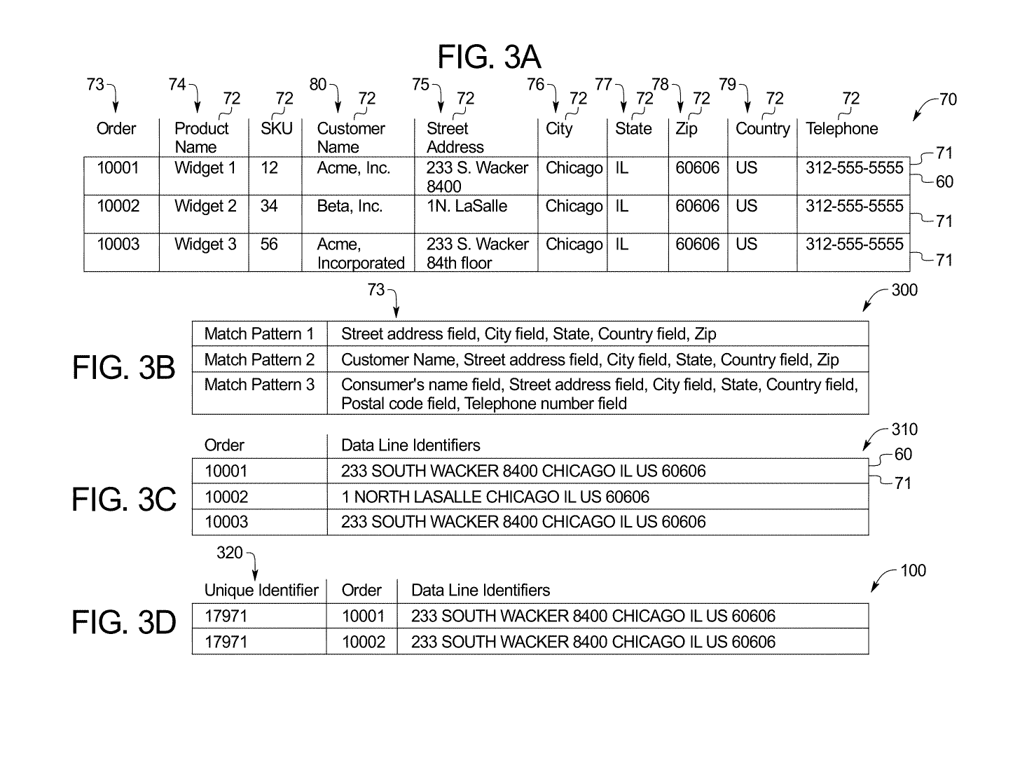

As shown in FIG. 2, the order fulfillment management system 10 may execute an order fulfillment management method 200. As shown in FIG. 2, using the order fulfillment management method 200, the controller may: at step 201, receive one or more data streams 70 of orders 60 from one or more retailers 75; at step 202, select two or more fields 72 of each order 60 according to a match pattern 300 (FIG. 3B); at step 203, concatenate the two or more selected fields 72 of each order to form a data line identifier 310 (FIG. 3C); at step 204, compare each data line identifier 310 to each of the other data line identifiers 310 from the data stream 70 to form one or more matches 100, each match 100 including two or more orders 60 having matching data line identifiers 310; at step 205, assign a unique identifier 320 to each of the one or more matches 100; and, at step 206, generate a packing list 500 including the unique identifier 320 and the product field 74 associated with each match 100 of the one or more matches 100.

The order fulfillment management method 200 begins at step 201, with the order fulfillment management system 10 receiving a data stream 70 of orders 60. Orders 60 may be received as a file transferred by file transfer protocol (FTP), via an application programming interface (API), etc. The data stream 70 may be a comma-separated values text file, a text file of any other delimiter-separated values, etc. As shown in FIG. 3A, the data stream 70 may include a plurality of data lines 71. Each data line 71 may include various fields 72 constituting an order 60, such as a product field 74 for the name of product ordered or the SKU number, and fields describing a shipping address for the order 60, such as, a street address field 75, a city field 76, state field 77, postal code field 78, etc. As shown, each field 72 may have a field identifier 73 to permit addressing each field 72 for each data line 71.

Next, at step 202, the order fulfillment management system 10 selects two or more fields 72 of each order 60 according to a match pattern 300. A match pattern 300 is a list of two or more fields 72 of a data line 71. In one example, a match pattern 300 includes a street address field 75, a city field 76, a state field 77, a postal code field 78, and a country column 79. In some embodiments, the match pattern 300 may include a consumer's name field 80. Similarly, in some embodiments, the match pattern 300 may include a telephone number field 81. In some embodiments multiple match patterns 300 may be used to find matches 100.

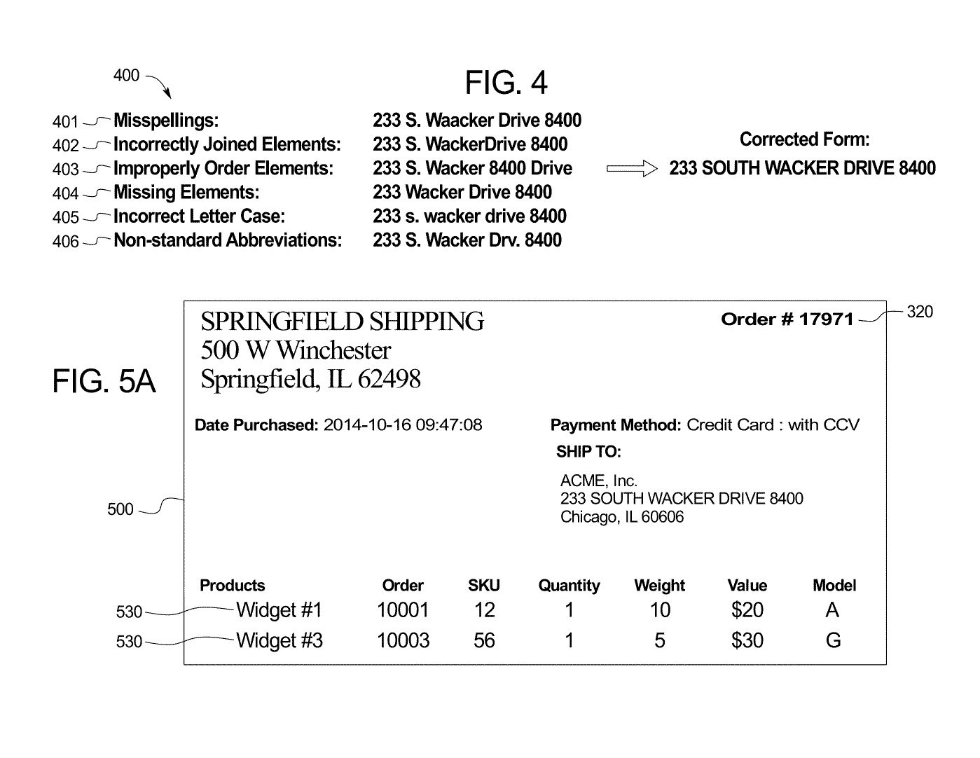

Then, at step 203, the order fulfillment management system 10 concatenates the field data of the two or more selected fields 72 of each order 60 to form a data line identifier 310. In some embodiments, as shown in FIG. 4, before concatenation, the order fulfillment management system 10 corrects errors 400 in the selected fields 72. Errors 400 may include misspellings 401, incorrectly joined elements 402, improperly ordered elements 403, and missing elements 404, incorrect letter case 405, and nonstandard abbreviations 406.

In the following step 204, as shown in FIG. 3D the order fulfillment management system 10 compares each data line identifier 310 to each of the other data line identifiers 310 from the data stream 70 to form one or more matches 100. Each match 100 includes two or more orders 60 having matching data line identifiers 310.

In some embodiments, the data line identifiers 310 for two data lines 71 must match identically to find a match 100. For example, in an embodiment, the data line identifiers 310 are constructed from a match pattern 300 that specifies the shipping address for the order 60 and requires an identical match. In an embodiment, a match pattern 300 specifying a shipping address includes a street address field 75, a city field 76, a state field 77, a postal code field 78.

However, it is contemplated that fields 72 need not be identical for a match to be found. Each field 72 of a match pattern 300 may be weighted to form a combined match score that may be used to determine a match 100 if the combined match score exceeds a desired threshold. Also, the match 100 may be accomplished by determining that the data line identifiers 310 of a candidate match meet a similarity threshold for finding a match.

Additionally, in some embodiments, the match pattern 300 may be run across multiple data streams 70. For example, when a data stream 70 is received, there may exist previously received data streams 70 that remain unprinted. The match pattern 100 may then be run between the new data stream 70 and the previously received data streams 70. Likewise, after a data stream 70 is received, it may be purposefully held unprinted until the passage of a period of time or until a number of other data streams 70 have been received to permit the discovery of further order 60 that may be combined. For example, in an embodiment, at least one of the one or more data streams 70 of orders 60 is held for a predetermined period of one day or greater after receipt of the data stream 70 before the step of concatenating the two or more fields 72 of each order to form a data line identifier 310. In another embodiment, the period of time is two days or greater. In yet another embodiment, the period of time is three days or greater.

In some embodiments, the customer 62 may select the predetermined period of time. For example, when checking out, the customer 62 may be provided with an input or selection box to indicate a period of time to hold open the order 60 for further combination with future orders 60. For example, the customer 62 may select a period of two days from a drop-down box including six hours, one day, two days, etc. as options. In an embodiment, the period of time may be provided by the customer 62 may be included as a field 72 in the customer's order 60. In other embodiments, the shipping management system 10 may receive the customer's desired period of time by any other conventional means. Similarly, it is contemplated that the retailer 15 may communicate a desired period of time to the shipping management system 10 for use as the period of time to hold open the order 60 for combination with future orders 60.

In some embodiments, the data streams 70 received may comprise different formats. In such embodiments, the match pattern 300 may include a selection of two or more fields 72 of each order 60 for each of the different formats. Additionally, to match across data streams 70 of different formats, the match pattern 300 may include a selection of fields 72 specific to a particular format. The match pattern 300 may include a mapping of fields 72 from one format to another.

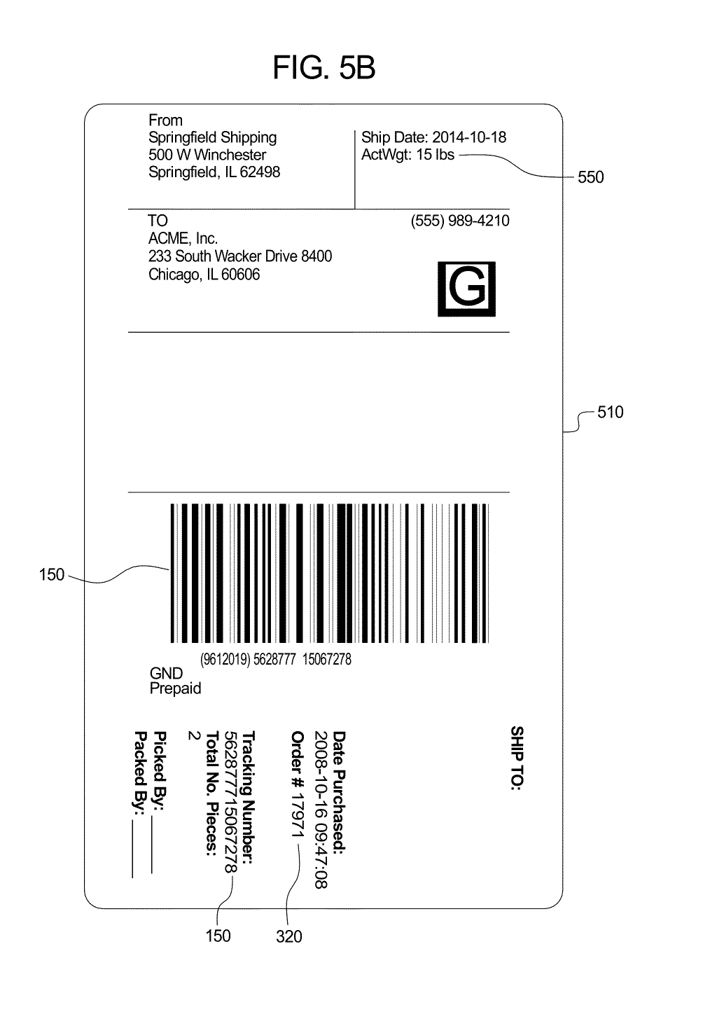

For each collection of matched orders 60, at step 205, the matched orders 60 are removed from the data stream 70, formed into a combined order 60, and assigned a unique identifier 320, such as a barcode or any combination of characters and alphanumeric values. The uncombined orders 60 are then printed as normal, producing one or both of a packing list 500 (FIG. 5A) and a shipping label 510 (FIG. 5B) for each order 60. A packing list 500 may be any manifest document for product picking from the warehouse or storage facility. The combined orders 60 are then printed on a packing list 500 and for each order the packing list 500 includes each of the products 530 of the combined order 60 as indicated in the product field 74 along with the unique identifier 320. The order fulfillment management system 10 may print the packing list 500 via the printer 90.

It is contemplated that in some embodiments, the steps 202-205 of matching orders 60 and assigning a unique identifier 320 to each match 100 may be accomplished in different ways utilizing greater or fewer steps. Accordingly, it is contemplated that steps 202-205 may be accomplished by any set of steps that assign a unique identifier 320 to two or more orders 60 having matching field data for one or more fields specified by a match pattern 300.

In some embodiments, the order fulfillment management method 200 may include further steps for printing a shipping label 510 for each combined order. First, at step 207, the order fulfillment management system 10 communicates the one or more matches 100 to a carrier system 17, including a total value and a weight 550 of two or more combined products 530. Next, at step 208, the order fulfillment management system 10 receives an electronic file 125 including an electronic representation of a shipping label 120 including a tracking number 150 from the carrier system 17. Then, order fulfillment management system 10 prints a shipping label based on the electronic representation of the shipping label 510 via the printer 90. In some embodiments, the shipping label 510 may be a combined shipping label 510 and packing list 500 or any other form of manifest adapted for shipping goods. The tracking number 150 may be transmitted back to the customer 62 for each order 60. Thus, if three orders 60 were combined, the same tracking number 150 will be provided to the customer 62 for all three orders 60. The tracking number 150 may then be communicated back to the customer 62, for example, by an email notification 140 that the order 60 has shipped.

Aspects of the systems and methods described herein are controlled by one or more controllers 20. The one or more controllers 20 may be adapted run a variety of application programs, access and store data, including accessing and storing data in associated databases, and enable one or more interactions via the order fulfillment management system 10. Typically, the one or more controllers 20 are implemented by one or more programmable data processing devices. The hardware elements, operating systems, and programming languages of such devices are conventional in nature, and it is presumed that those skilled in the art are adequately familiar therewith.

For example, the one or more controllers 20 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory 40, such as a dynamic random access memory (DRAM) and cache, as well as a read only memory, such as a PROM, EPROM, FLASH-EPROM, or the like. The system may also include any form of volatile or non-volatile memory 40. In operation, the main memory 40 stores at least portions of instructions for execution by the CPU and data for processing in accord with the executed instructions.

The one or more controllers 20 may also include one or more input/output interfaces for communications with one or more processing systems. One or more such interfaces may include a network interface 30 to enable communications via a network 50, e.g., to enable sending and receiving instructions electronically. The communication links may be wired or wireless.

The one or more controllers 20 may further include appropriate input/output ports for interconnection with one or more output displays (e.g., monitors, printers, touchscreen, motion-sensing input device, etc.) and one or more input mechanisms (e.g., keyboard, mouse, voice, touch, bioelectric devices, magnetic reader, RFID reader, barcode reader, touchscreen, motion-sensing input device, etc.) serving as one or more user interfaces for the processor. For example, the one or more controllers 20 may include a graphics subsystem to drive the output display. The links of the peripherals to the system may be wired connections or use wireless communications.

Although summarized above as a PC-type implementation, those skilled in the art will recognize that the one or more controllers 20 also encompasses systems such as host computers, servers, workstations, network terminals, and the like. Further one or more controllers 20 may be embodied in a device, such as a mobile electronic device, like a smartphone or tablet computer. In fact, the use of the term processor is intended to represent a broad category of components that are well known in the art.

Hence aspects of the systems and methods provided herein encompass hardware and software for controlling the relevant functions. Software may take the form of code or executable instructions for causing a controller 20 or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a controller 20 for execution.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. An order fulfillment management system comprising:
a controller;
a network interface coupled to the controller; and
a memory coupled to the controller, wherein the memory is configured to store program instructions executable by the controller, wherein in response to executing the program instructions, the controller is configured to:
receive one or more data streams of orders from the network interface, each order including a plurality of fields, wherein each field is identified by a corresponding field identifier, wherein the plurality of fields include a field identified by a corresponding field identifier as a product field, wherein the plurality of fields include fields identified by corresponding field identifiers as portions of an address;
assign a unique identifier to two or more orders of the one or more data streams of orders having matching fields for each of one or more fields specified by a match pattern to form a match, wherein the match pattern specifies a plurality of field identifiers; and
generate a packing list for the match including the unique identifier and a product field for the two or more orders of the match.

2. The order fulfillment management system of claim 1, wherein the two or more orders include a first order and a second order, wherein the first order is received in a first data stream of orders, wherein the second order is received in a second data stream of orders, wherein the first data stream of orders is distinct from the second data stream of orders, wherein the second data stream of orders is received a period of time after the first data stream of orders is received.

3. The order fulfillment management system of claim 2, wherein the period of time is one day or greater.

4. The order fulfillment management system of claim 2, wherein the period of time is two days or greater.

5. The order fulfillment management system of claim 2, wherein the period of time is three days or greater.

6. The order fulfillment management system of claim 1, wherein the one or more field identifiers specified by the match pattern includes a street address field, a city field, a state field, a country field, and a postal code field.

7. The order fulfillment management system of claim 6, wherein the one or more field identifiers specified by the match pattern further includes a consumer's name field.

8. The order fulfillment management system of claim 6, wherein the one or more field identifiers specified by the match pattern further includes a telephone number field.

9. The order fulfillment management system of claim 1, wherein the one or more field identifiers specified by the match pattern includes a consumer's name field, a street address field, a city field, a state field, a country field, a postal code field, and a telephone number field.

10. The order fulfillment management system of claim 1, wherein the controller is further configured to, before the step of assigning a unique identifier, correct errors in the one or more fields specified by the match pattern for each order of the one or more data streams of orders, wherein errors include misspellings, incorrectly joined elements, improperly ordered elements, and missing elements.

11. The order fulfillment management system of claim 10, wherein errors further include incorrect letter case.

12. The order fulfillment management system of claim 11,wherein errors further include nonstandard abbreviations.

13. The order fulfillment management system of claim 1, further including a printer coupled to the controller, wherein the controller is further configured to:
communicate the match to a carrier system, including a total value and a weight of two or more combined products;
receive an electronic file including an electronic representation of a shipping label including a tracking number from the carrier system; and
print the shipping label based on the electronic representation of the shipping label via the printer.

14. The order fulfillment management system of claim 1, further including a printer coupled to the controller, wherein the controller is further configured to:
print the packing list via the printer.

15. The order fulfillment management system of claim 1, wherein to assign the unique identifier, the controller is further configured to:
concatenate two or more fields of each order of the one or more data streams of orders according to the match pattern to form a data line identifier; and
assign the unique identifier to the two or more orders of the one or more data streams of orders having matching data line identifiers to form the match.

16. An order fulfillment management system comprising:
a controller;
a network interface coupled to the controller;
one or more printers in communication with the controller; and
a memory coupled to the controller, wherein the memory is configured to store program instructions executable by the controller, wherein in response to executing the program instructions, the controller is configured to:
receive one or more data streams of orders from the network interface, each order including a plurality of fields, wherein each field is identified by a corresponding field identifier, wherein the plurality of fields include a field identified by the corresponding field identifier as a product field, wherein the plurality of fields include fields identified by the corresponding field identifiers as portions of an address;
assign a unique identifier to two or more orders of the one or more data streams of orders having matching fields for each of one or more fields specified by a match pattern to form a match, wherein the match pattern specifies a plurality of field identifiers;
generate a packing list for the match including the unique identifier and the product fields for the two ore more orders of the match;
communicate the packing list to one of the printers;
communicate the match to a carrier system, including a total value and a weight of two or more combined products;
receive an electronic file including an electronic representation of a shipping label including a tracking number from the carrier system; and
communicate the electronic representation of the shipping label to one of the printers.

17. The order fulfillment management system of claim 16, wherein the two or more orders include a first order and a second order, wherein the first order is received in a first data stream of orders, wherein the second order is received in a second data stream of orders, wherein the first data stream of orders is distinct from the second data stream of orders, wherein the second data stream of orders is received a period of time after the first data stream of orders is received.

18. The order fulfillment management system of claim 16, wherein the one or more field identifiers specified by the match pattern includes a street address field, a city field, a state field, a country field, and a postal code field.

19. The order fulfillment management system of claim 16, wherein the controller is further configured to:
for each order of the one or more data streams of orders, before the step of assigning a unique identifier, correct errors in the each field specified by the match pattern, wherein the errors include misspellings, incorrectly joined elements, improperly ordered elements, incorrect letter case, nonstandard abbreviations, and missing elements.

20. An order fulfillment management system comprising:
a controller;
a network interface coupled to the controller; and
a memory coupled to the controller, wherein the memory is configured to store program instructions executable by the controller, wherein in response to executing the program instructions, the controller is configured to:
receive a first order from the network interface, the first order associated with a user-specified period of time;
during the specified period of time, receive one or more data streams of orders from the network interface, wherein each order of the first order and the data streams of orders include a plurality of fields, wherein each field is identified by a corresponding field identifier, wherein the plurality of fields include a field identified by a corresponding field identifier as a product field, wherein the plurality of fields include fields identified by corresponding field identifiers as portions of an address;
assign a unique identifier to the first order and a second order of the one or more data streams of orders to form a match, wherein the fields of the first order and the second order specified by a match pattern match identically; and
generate a packing list for the match including the unique identifier and a product field for the two or more orders of the match.
